(19) United States
(12) Patent Application Publication
(10) Pub. No.: US 2004/0116680 A1
(43) Pub. Date: Jun. 17, 2004

(54) Photolabile protective groups for the synthesis of biopolymers

(76) Inventor: Markus Beier, Heidelberg (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/470,939

(22) PCT Filed: Feb. 5, 2002
(86) PCT No.: PCT/EP02/01187

(30) Foreign Application Priority Data
Feb. 5, 2001 (DE) 10105079.8

(51) Int. Cl. C09B 29/033

(52) U.S. Cl. 534/751; 534/856

(57) ABSTRACT

The present invention relates to photolabile protective groups for synthesizing biopolymers, in particular nucleic acids.

### DESCRIPTION

The present invention relates to photolabile protective groups for synthesizing biopolymers, in particular nucleic acids.

The technology of the light-controlled synthesis of biopolymers using photolabile protective groups opens up the possibility of producing biochips in situ by synthesizing them from monomeric or oligomeric building blocks. Biochips have gained quite substantially in importance for research and diagnosis since they enable complex biological questions to be processed rapidly and in a highly parallel manner. However, chips of the highest quality are required for this purpose, which means that there is a great interest in novel and efficient methods of synthesis.

Photolabile nucleoside derivatives are used in the light-controlled synthesis of nucleic acid chips. In this procedure, the chains of the nucleic acid fragments are usually constructed using phosphoramidite synthons. Each of the building blocks carries a temporary photoprotective group which can be removed by irradiating with light. The principle of the synthesis envisages a cyclic sequence of, in particular, condensation and deprotection steps (using light). The efficiency with which such a light-controlled synthesis can take place is essentially determined by the photo-labile protective groups which are used, in particular by the efficiency with which these groups can be removed in the irradiation step. The photoprotective groups which have so far been used for light-controlled synthesis are the NVOC(S. P. A. Fodor et al., Science 251 (1991), 767 ff.), MeNPOC (A. C. Pease et al., Proc. Natl. Acad. Sci. 91 (1994), 5022 ff.), DMBOC (M. C. Pirrung, J. Org. Chem. 60 (1995), 1116 ff.) and the NPPOC protective groups (A. Hassan et al., Tetrahedron 53 (1997), 4247 ff.). Other photolabile protective groups which are known in nucleoside and/or nucleotide chemistry are o-nitrobenzyl groups and their derivatives (cf., e.g., Pillai, Org. Photochem. 9 (1987), 225; Walker et al., J. Am. Chem. Soc. 110 (1988), 7170). The 2-(o-nitrophenyl)ethyl group (Pfleiderer et al., in: “Biophosphates and their Analogues-Synthesis, Structure, Metabolism and Activity”, ELSEVIER Science Publishers B. V. Amsterdam (1987), 133 ff.) and derivatives thereof (WO 97/44345 and WO 96/18634) have been proposed as additional photolabile protective groups.

In general, the photolabile protective groups (e.g. NVOC, MeNPOC and NPPOC) which are currently being used for the light-controlled synthesis of nucleic acids are characterized by having a comparatively low absorption coefficient at the wavelength of the irradiating light. The photolabile nucleoside derivatives are usually irradiated using Hg high pressure lamps at a wavelength of 365 nm. The fact that the photolabile protective groups which are used only have a low absorption coefficient at this wavelength means that only a very small proportion of the impinging light can be utilized for exciting the molecule. In addition, most of the photolabile protective groups employed are colorless derivatives. This in turn has the consequence that it is not possible, during the synthesis, to use simple spectroscopic methods to detect whether the photolabile protective group is still present on the nucleoside derivative or whether it has already been partly or completely eliminated by the light which has been absorbed. As a result, the process of elimination can only be monitored with difficulty or not monitored at all.

The object of the invention was now, by providing novel photolabile nucleoside derivatives, to increase the utilization of the irradiating light and thereby significantly increase the rate of elimination of the photoprotective groups itself. This is achieved by using photolabile protective groups which are characterized by the fact that they comprise a chromophore system of the azo dye type. The chromophore of the azo dye leads to the photolabile protective group having a substantially higher absorption coefficient at the irradiating wavelength. As a consequence, a substantially higher proportion of the irradiating light can be used for raising the photoprotective group molecule into the excited state. This results in the derivatives according to the invention being eliminated particularly rapidly.

In addition, the color of the photoprotective groups according to the invention serves the purpose of making it possible to track and monitor the process of elimination particularly easily on-line.

The invention relates to a compound of the general formula (I)

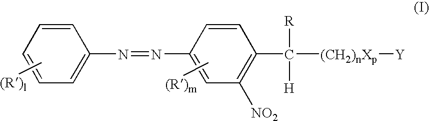

in which

R is H, halogen, CN, NO₂, N(R″)₂, NH—COR″, NR″—COR″ or an optionally substituted C₁-C₄-alkyl, alkenyl, alkynyl or alkoxy radical or an optionally substituted aryl radical,

R′ is, in each case independently, halogen, CN, NO₂, N(R″)₂, NH—COR″, NR″—COR″ or an optionally substituted C₁-C₄-alkyl, alkenyl, alkynyl or alkoxy radical or an optionally substituted aryl radical, where several adjacent R′ groups can, where appropriate, form a ring system,

R″ is, in each case independently, an optionally substituted C₁-C₄-alkyl radical or an optionally substituted aryl radical,

l is an integer from 0 to 5,

m is an integer from 0 to 3,

n is an integer from 0 to 4,

p is 0 or 1,

X is a group selected from:

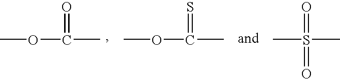

and

Y is a leaving group.

Substituents of alkyl, alkenyl, alkynyl or aryl groups are preferably selected from halogen, e.g. F, Cl, Br or I, OH, SH, —O—, —S(O)—, —S(O)₂—, NO₂ or CN. The substituents can be present once or more than once on the radical concerned. Aryl groups can also include ring systems containing heteroatoms such as O, N and/or S.

R can, for example, be CH₃ and n can be 0 or 1.1 and m are preferably integers of from 0 to 3, particularly preferably from 0 to 1. n is preferably an integer of from 0 to 2.

The leaving group Y is a group which can be eliminated when the compound (I) reacts with another compound. Y is preferably a leaving group which can be eliminated by reaction with a nucleophile, where appropriate in the presence of an auxiliary base, e.g. pyridine. Examples of suitable leaving groups are:

Cl, Br, I, aryl, e.g. phenyl, mesylate, tosylate or trifluorosulfonate,

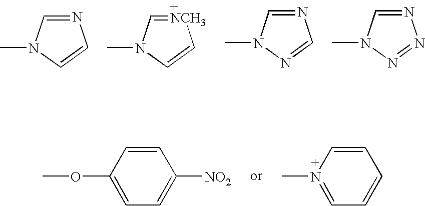

The compounds (I) are suitable for preparing protected synthons for the light-controlled synthesis of biopolymers such as peptides, peptide nucleic acids (PNAs) or carbohydrates and, in particular, of nucleic acids, such as DNA or RNA. Monomeric biopolymer building blocks, e.g. nucleotides or nucleotide derivatives, and also oligomeric building blocks, in particular dimers or trimers, can be used as synthesis. Examples of suitable synthons for nucleic acids are protected phosphates, H-phosphonates or phosphoramidites, with phosphoramidites being particularly preferred. It is furthermore possible to use linker building blocks or spacer building blocks, e.g. phosphoramidites, as synthons.

The invention consequently also relates to a protected synthon for the light-controlled synthesis of biopolymers, which synthon carries one or more photo-labile protective groups Z which has/have been produced by reacting the synthon with a compound (I), as previously specified, by replacing Y. The synthon is preferably a synthon for synthesizing nucleic acids and particularly preferably a phosphoramidite building block.

Synthons according to the invention can, for example, exhibit the general formulae (IIa), (IIb), (IIc) or (IId):

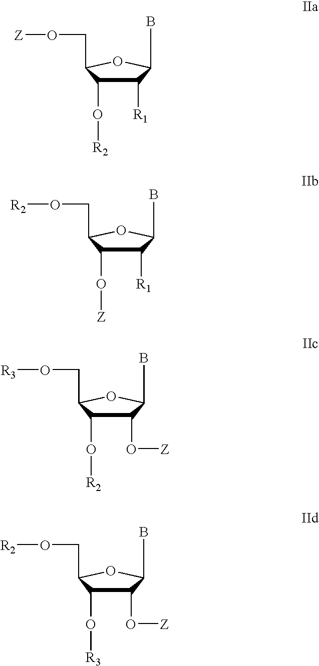

in which

B is hydrogen or an organic radical, e.g. an optionally substituted C₁-C₁₀ alkyl radical, such as CH₃, and preferably a heterocyclic base, in particular a nucleobase, e.g. a pyrimidine base, such as cytosine, thymine or uracil, or an unnatural pyrimidine base, such as 5-methyl-cytosine, or a purine base, such as adenine or guanine, or an unnatural purine base, such as 2,6-diaminopurine, hypoxanthine or xanthine, with it being optionally possible for the nucleobase to carry protective groups,

Z is formed from the compound (I) by replacing Y,

R¹ is H, OH, R or OR, where R is as previously defined for the compound (I), or a protective group (e.g. an acid-labile or base-labile protective group which is different from Z),

one of R² and R³ is an optionally protected phosphate, phosphonate or phosphoramidite group and the other is H or a protective group (e.g. an acid-labile or base-labile protective group which is different from Z).

The protected synthons according to the invention can be used for the light-controlled synthesis of biopolymers, with a high degree of light absorption, and consequently a more efficient elimination, being ensured due to the high absorption coefficient, and optical monitoring of the elimination of the protective group Z being possible, e.g. during the synthesis, due to its color.

The compounds (I) and synthons according to the invention can essentially be prepared in analogy with the methods described in WO 96/18634, WO 97/44345 or WO 00/61594.

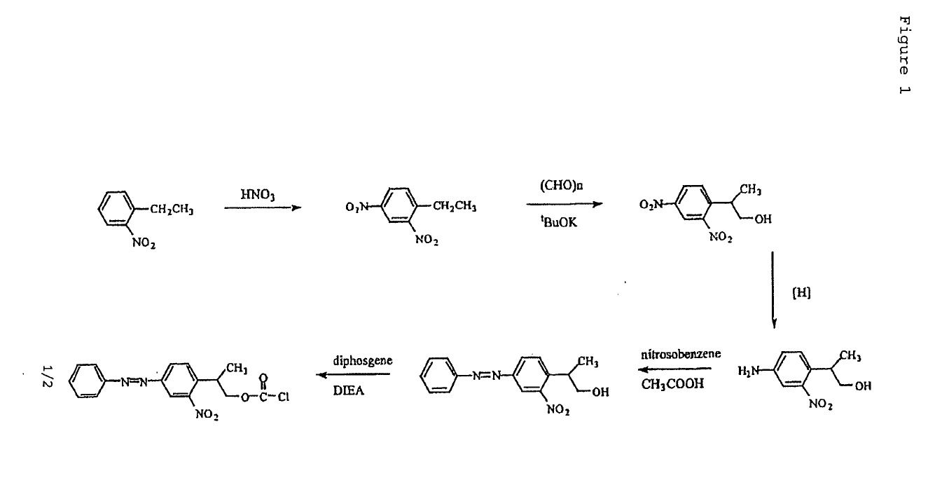

The synthesis of the compound (I) according to the invention is shown, by way of example, in FIG. 1. (o-Nitro)ethylbenzene is converted into (o,p-dinitro)-ethylbenzene by nitration. A CH₂OH group is then introduced on the ethyl radical by reacting with formaldehyde in the presence of potassium tert-butoxide. The nitro group located in the p-position is reduced to the amino group by reducing, for example with Pd/H. This amino group is in turn reacted with nitrosobenzene in an azo coupling reaction. The OH group is in turn reacted with diphosgene to give a chlorocarbonic ester, with the compound (I) being obtained.

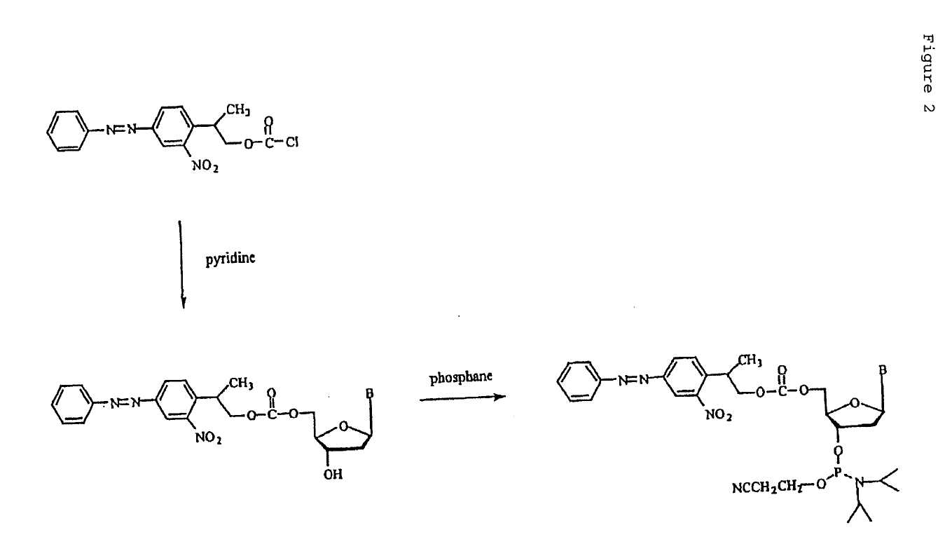

FIG. 2 shows the preparation of protected nucleoside derivatives. For this purpose, the compound (I) is coupled to the 5′-OH group of a nucleoside using pyridine as an auxiliary base. A phosphoramidite function is then introduced on the 3′-OH group of the nucleoside.

1. A compound of the general formula 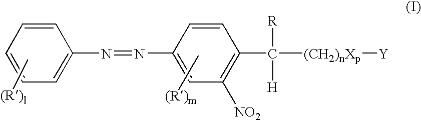
in which
R is H, halogen, CN, NO₂, N(R″)₂, NH—COR″, NR″—COR″ or an optionally substituted C₁-C₄-alkyl, alkenyl, alkynyl or alkoxy radical or an optionally substituted aryl radical,
R′ is, in each case independently, halogen, CN, NO₂, N(R″)₂, NH—COR″, NR″—COR″ or an optionally substituted C₁-C₄-alkyl, alkenyl, alkynyl or alkoxy radical or an optionally substituted aryl radical, where several adjacent R′ groups can, where appropriate, form a ring system,
R″ is, in each case independently, an optionally substituted C₁-C₄-alkyl radical or an optionally substituted aryl radical,
l is an integer from 0 to 5,
m is an integer from 0 to 3,
n is an integer from 0 to 4,
p is 0 or 1,
X is a group selected from: 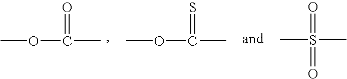
and
y is a leaving group.

2. A compound as claimed in claim 1
characterized in that
R is CH₃ and n is 0 or 1.

3. A compound as claimed in claim 1 or 2,
characterized in that
Y is a leaving group which can be eliminated by reaction with a nucleophile, where appropriate in the presence of an auxiliary base.

4. A compound as claimed in one of claims 1 to 3,
characterized in that
Y is selected from:
Cl, Br, I, aryl, mesylate, tosylate, trifluoro-sulfonate,

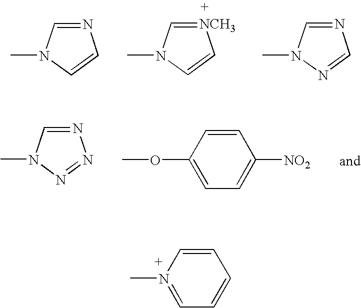

5. The use of a compound as claimed in one of claims 1 to 4 for preparing protected synthons for the light-controlled synthesis of biopolymers.

6. The use as claimed in claim 5 for synthesizing nucleic acids, e.g. DNA or RNA.

7. The use as claimed in claim 6,
characterized in that
the synthon is a phosphoramidite.

8. A protected synthon for the light-controlled
synthesis of biopolymers,
characterized in that
it carries at least one photolabile protective group Z which is produced by reacting the synthon with a compound as claimed in one of claims 1 to 4, by replacing Y.

9. A synthon as claimed in claim 8
characterized in that
it is a phosphoramidite building block.

10. A synthon as claimed in claim 8 or 9 having the general formula (IIa), (IIb), (IIc) or (IId) 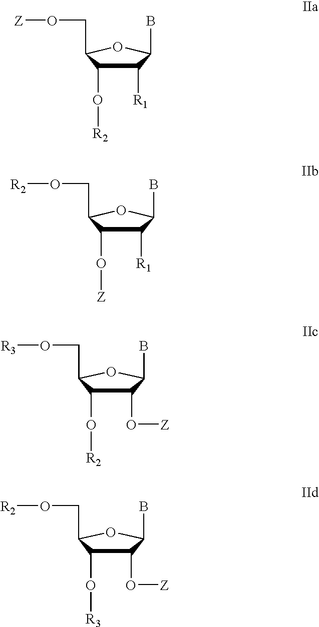
in which
B is hydrogen or an organic radical, in particular a heterocyclic base,
Z is formed from the compound (I) by replacing Y,
R¹ is H, OH, R or OR, where R is as defined in claim 1, or is a protective group,
one of R² and R³ is an optionally protected phosphate, phosphonate or phosphoramidite group and the other is H or a protective group.

11. A synthon as claimed in one of claims 8 to 19,
characterized in that
B is a natural or unnatural nucleobase.

12. A synthon as claimed in one of claims 8 to 11,
characterized in that
Z is a chromatic group.

13. The use of a protected synthon as claimed in any one of claims 8 to 12 for the light-controlled synthesis of biopolymers.

14. The use as claimed in claim 13,
characterized in that
the elimination of the protective group Z is monitored optically.
